(19) United States
(12) Patent Application Publication
(10) Pub. No.: US 2010/0185526 A1
(43) Pub. Date: Jul. 22, 2010

(54) METHOD AND SYSTEM OF ELECTRONIC COMMERCE TRADE

(75) Inventor: Xiaoyou Li, Shenzhen (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: TENCENT TECHNOLOGY(SHENZHEN) LIMITED, SHENZHEN (CH)

(21) Appl. No.: 12/677,036

(22) PCT Filed: Aug. 21, 2008
(86) PCT No.: PCT/CN2008/072078

§ 371 Date: Mar. 8, 2010

(30) Foreign Application Priority Data
Sep. 29, 2007 (CN) 200710123665.1

(51) Int. Cl. G06Q 30/00; G06Q 20/00; G06F 17/30; G06F 15/16

(52) U.S. Cl. 705/26; 707/705; 707/E17.001; 709/217

(57) ABSTRACT

A method of electronic commerce trade includes generating an on-line order for each of commodities selected to buy by a user; receiving multiple on-line payment requests initiated once by the user for multiple selected on-line orders; and performing payments according to the multiple on-line payment requests. A system of electronic commerce trade includes an order generating module adapted to generate an on-line order for each of commodities selected to buy by a user; and an order payment module adapted to receive multiple on-line payment requests initiated once by the user for multiple selected on-line orders, and perform payments according to the multiple on-line payment requests, the multiple selected on-line orders being selected by the user from the on-line orders generated by the order generating module.

The application claims priority to and expressly incorporates by reference Chinese patent application No. 200710123665.1 and name “method and system of electronic commence trade” filed Sep. 29, 2007.

### FIELD OF THE INVENTION

The present invention relates to computer network technologies, and more particularly to a method and system of electronic commerce trade.

### BACKGROUND OF THE INVENTION

On-line purchase and on-line payment are two most important steps in an electronic commerce trade system. The on-line purchase generates a purchase confirmation, purchase finish represents that a buyer has accepted an offer of a seller, and a trade agreement becomes effective; and the on-line payment represents that the buyer has performed obligations about payment stipulated in the trade agreement.

Currently, in a commodity purchase and bid technology adopted in three main trade systems of the electronic commerce industry, i.e. Business to Business (B2B), Business to Customer (B2C) and Customer to Customer (C2C), only a single on-line order can be generated for one or multiple commodities once; after the on-line order is generated, the buyer must pay for all commodities in the on-line order, and it is not supported that multiple on-line orders are freely selected and combined or two trade parties freely combine the on-line orders and perform other management operations, which reduces the flexibility of trades.

### SUMMARY OF THE INVENTION

Embodiments of the present invention provide a method of electronic commerce trade to solve a problem that the conventional electronic commerce trade system can only generate a single on-line order for one or multiple commodities once and can not support that multiple on-line orders are freely selected and combined.

A method of electronic commerce trade includes:
generating an on-line order for each of commodities selected to buy by a user;
   receiving multiple on-line payment requests initiated once by the user for multiple selected on-line orders; and
performing payments according to the multiple on-line payment requests.

A system of electronic commerce trade includes:
an order generating module, adapted to generate an on-line order for each of commodities selected to buy by a user; and
an order payment module, adapted to receive multiple on-line payment requests initiated once by the user for multiple selected on-line orders, and perform payments according to the multiple on-line payment requests, the multiple selected on-line orders being selected by the user from the on-line orders generated by the order generating module.

In the embodiments of the present invention, the user can select different commodities to perform batch on-line purchases, generate multiple on-line orders, freely combine the on-line orders, and thus finish on-line payments of the multiple on-line orders once. Hence, the user can rapidly perform batch purchases and payments, which can greatly simplify the trade operation flow, reduce purchase time and improve the flexibility of trades. At the same time, the seller can freely combine the on-line orders and perform batch management, and thus management cost is saved.

### BRIEF DESCRIPTION OF THE DRAWINGS

FIG. 1 is a schematic diagram illustrating a structure of an electronic commerce system in accordance with an embodiment of the present invention.

FIG. 2 is a flowchart illustrating a method of electronic commerce trade in accordance with an embodiment of the present invention.

FIG. 3 is a schematic diagram illustrating a structure of an electronic commerce trade system in accordance with an embodiment of the present invention.

### DETAILED DESCRIPTION OF THE INVENTION

In order to make the object, technical solution and merits clearer, the present invention will be illustrated hereinafter in detail with reference to the accompanying drawings and the embodiments. It should be understood that the embodiments described herein are merely used to explain the present invention and are not used to limit the present invention.

In the embodiments of the present invention, multiple independent on-line orders are generated for multiple commodities selected by a user, the on-line orders can be combined freely, and payments can be performed for multiple on-line payment requests which are sent by the user once for multiple selected on-line orders, thereby improving the flexibility of the electronic commerce trade.

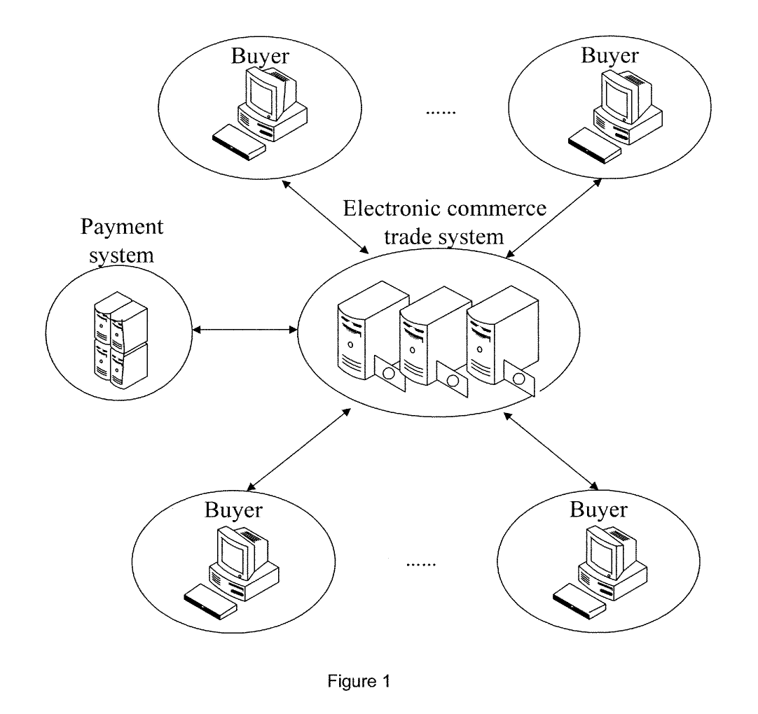

FIG. 1 is a schematic diagram illustrating a structure of an electronic commerce system in accordance with an embodiment of the present invention. A seller logs on an electronic commerce trade system through a network terminal, and issues commodity information. A buyer logs on the electronic commerce trade system through a network terminal, performs operations including commodity selection, purchase and the like, and finishes trade payment by using a payment system connected with the electronic commerce trade system, e.g. a counter system of a bank. The network terminal may be a computer, a Personal Digital Assistant (PDA), a mobile phone and so on, and is connected with the electronic commerce trade system through a wired network or a wireless network.

The electronic commerce trade system is operated by an electronic commerce agency, and generally is a software system installed in a server. In order to improve operation performance, there are usually several servers. The electronic commerce trade system is generally displayed to a user through a Web interface. If the user is unregistered, the user needs to input necessary information on the Web interface according to system demands to finish the registration and obtain information including a user name and a password for logging on the electronic commerce trade system. If the user has been registered, the user is verified by inputting the user name and the password, and when the verification is successful, the user logs on the electronic commerce trade system.

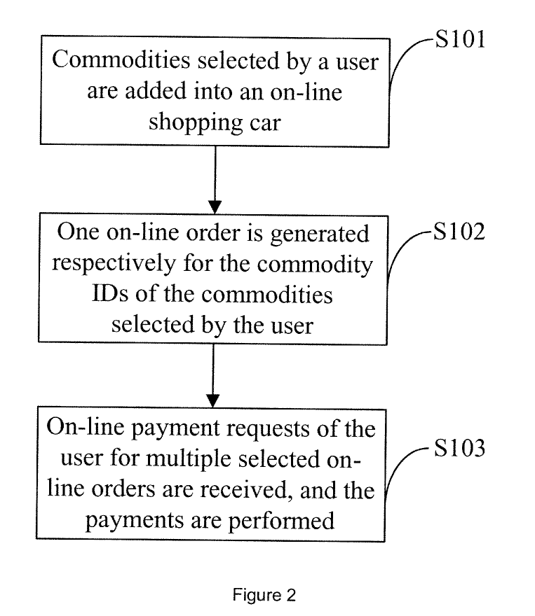

FIG. 2 is a flowchart illustrating a method of electronic commerce trade in accordance with an embodiment of the present invention, which is described in detail as follows.

In step S101, commodities selected by a user are added into an on-line shopping cart.

In the embodiments of the present invention, the user may scan commodities of different sellers, and add the selected commodities into the on-line shopping cart. The on-line shopping cart actually is a data cache, and is adapted to temporarily store attribute information of the commodities selected by the user. The maximum information amount which the on-line shopping cart can store may be configured by a system in advance, or may be configured by the user. The attribute information of the commodities stored in the on-line shopping cart includes information such as commodity identities (IDs), commodity names, seller names, commodity quantities, payment sums etc. The commodity IDs may be used to differentiate different commodities and different sellers of the commodities. The user may perform operations including deleting, collecting, adding, modifying etc. for the attribute information of the commodities temporarily stored in the on-line shopping cart. When logging once again, the user may search for and obtain the attribute information of the selected commodities.

In an embodiment of the present invention, the attribute information of the commodities selected by the user may be stored in a special file of a user network terminal, i.e. the attribute information of the commodities may be written into a Cooke (a file used to temporarily store information in the network) of a user terminal browser. In another embodiment of the present invention, the attribute information of the commodities selected by the user is directly written into a background database of the system.

In step S102, one on-line order is generated respectively for the commodity IDs of the commodities selected by the user.

In the embodiment of the present invention, one on-line order is generated respectively for the commodities selected by the user and stored in the on-line shopping cart. The on-line orders are independent with each other, and the user may arbitrarily combine the on-line orders and select to pay for part of or all the on-line orders. The on-line order includes information such as a buyer ID, commodity IDs, commodity quantities, payment sums etc.

In step S103, on-line payment requests of the user for multiple selected on-line orders are received, and the payments are performed.

After selecting the on-line orders, the user sends multiple on-line payment requests to the system, and each on-line payment request corresponding to one on-line order. In the embodiment of the present invention, after the on-line payment requests of the user for multiple selected on-line orders are received, the on-line payment requests of the user are transmitted to a payment system. The user performs the payments through inputting verification information, such as a user name, a password etc.

In an embodiment of the present invention, the system can transmit to the payment system multiple parallel on-line payment requests for multiple on-line orders, and the on-line payment request of each on-line order includes information such as an order ID, a payment sum, buyer information etc. After the payments are successful, multiple payment response messages corresponding to the multiple on-line orders which the user requests to pay for are returned to the user. As an embodiment of the present invention, the system may pack multiple on-line orders which the user requests to pay for into one on-line payment request, and transmit the on-line payment request to the payment system. The on-line payment request includes the order ID of each on-line order, the payment sum of each on-line order, the buyer information of each on-line order, a total payment sum etc. When the payment is successful, one payment response message is returned to the user. The user can perform batch operations of on-line order management for each on-line order, e.g. commodities receipt, evaluation and the like.

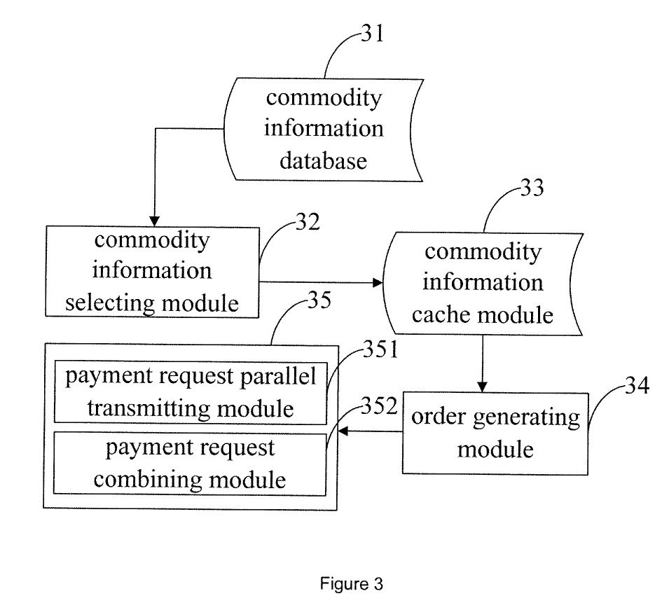

FIG. 3 is a schematic diagram illustrating a structure of an electronic commerce trade system in accordance with an embodiment of the present invention. In order to be convenient for description, only part of the structure related to the embodiment of the present invention is shown.

A commodity information database 31 stores information of all commodities issued in a system, including seller IDs (seller names, register numbers and so on), commodity IDs, commodity names, commodity prices, commodity quantities, commodity descriptions, commodity pictures, commodity advertisements, discount and promotion information etc. Generally, the seller IDs or the commodity IDs are regarded as indexes.

The commodity information stored in the commodity information database 31 is issued on a Web interface provided by the system, and after logging on the system, a user may scan and search for related commodity information. The user may select information of commodities to be bought on the Web interface, e.g., click a corresponding check box or a button on the Web interface provided by the system. A commodity information selecting module 32 receives a commodity information selecting request of the user, and store attribute information of the commodities selected to buy by the user to a commodity information cache module 33. The commodity information cache module 33 is also called as an on-line shopping cart and is adapted to temporarily store the attribute information of the commodities selected to buy by the user. The attribute information includes commodity IDs, commodity names, seller names, commodity quantities, payment sums and so on. The commodity IDs may be used to differentiate different commodities and different sellers of the commodities. The commodity information cache module 33 may be a Cooke in a user terminal browser or in a system background. The user can perform, through the commodity information selecting module 32, read-and-write operations such as deleting, collecting, adding etc for the attribute information of the commodities temporarily stored in the commodity information cache module 33.

An order generating module 34 generates on-line orders according to the attribute information of the commodities temporarily stored in the commodity information cache module 33. In the embodiment of the present invention, the order generating module 34 generates one on-line order respectively for the commodities, and the on-line order includes a seller ID, a commodity ID, a commodity quantity, a commodity price etc. The on-line orders are independent with each other, and the user may arbitrarily combine the on-line orders and select to pay for part of or all the on-line orders. An order payment module 35 receives on-line payment requests of the user for selected on-line orders, and transmits the on-line payment requests to a payment system to perform payments.

In an embodiment of the present invention, a payment request parallel transmitting module 351 can transmit to the payment system multiple parallel on-line payment requests for multiple on-line orders, and each on-line payment request corresponding to one on-line order. The on-line payment request includes information such as an order ID, a payment sum, buyer information etc. After the payment is successful, the payment request parallel transmitting module 351 returns a payment response message corresponding to each on-line payment request to the order generating module 34. In another embodiment of the present invention, a payment request combining and transmitting module 352 can pack multiple on-line orders which the user requests to pay for into one on-line payment request, and transmit the on-line payment request to the payment system. The on-line payment request includes the order ID of each on-line order, the payment sum of each on-line order, the buyer information of each on-line order, a total payment sum etc. When the payment is successful, a payment response message corresponding to the on-line payment request is returned to the order generating module 34. The user can perform batch operations of on-line order management for each on-line order, e.g. commodities receipt, evaluation and the like.

As an embodiment of the present invention, the order generating module 34 or the order payment module 35 may be a separated on-line order server or a payment gateway server.

In the embodiments of the present invention, the user can select different commodities to perform batch on-line purchases, generate multiple on-line orders, freely combine the on-line orders, and thus finish on-line payments of the multiple on-line orders once. Hence, the user can rapidly perform batch purchases and payments, which can greatly simplify the trade operation flow, reduce purchase time and improve the flexibility of trades. At the same time, the seller can freely combine the on-line orders and perform batch management, and thus management cost is saved. In addition, the embodiments of the present invention can be combined with the conventional electronic commerce trade system seamlessly, and it is unnecessary to adjust data and flows of the conventional electronic commerce trade system, so the function extensibility is strong.

The foregoing are only preferred embodiments of the present invention and are not for use in limiting the protection scope of the present invention. Any modification, equivalent replacement and improvement made within the scope of the present invention should be covered under the protection scope of the present invention.

1. A method of electronic commerce trade, comprising:
generating an on-line order for each of commodities selected to buy by a user;
receiving multiple on-line payment requests initiated once by the user for multiple selected on-line orders; and
performing payments according to the multiple on-line payment requests.

2. The method of claim 1, further comprising:
before generating an on-line order for each of commodities selected to buy by a user,
storing attribute information of the commodities selected by the user; and
generating one on-line order for each commodity ID of the commodities selected to buy by the user according to the attribute information of the commodities.

3. The method of claim 2, the attribute information of the commodities selected by the user is stored in a user network terminal or a background database of an electronic commerce trade system.

4. The method of claim 1, performing payments according to the multiple on-line payment requests comprises:
transmitting the multiple on-line payment requests in parallel to a payment system.

5. The method of claim 1, performing payments according to the multiple on-line payment requests comprises:
combining the multiple on-line payment requests into one on-line payment request; and
transmitting the combined on-line payment request to a payment system to perform payment.

6. A system of electronic commerce trade, comprising:
an order generating module, adapted to generate an on-line order for each of commodities selected to buy by a user; and
an order payment module, adapted to receive multiple on-line payment requests initiated once by the user for multiple selected on-line orders, and perform payments according to the multiple on-line payment requests, the multiple selected on-line orders being selected by the user from the on-line orders generated by the order generating module.

7. The system of claim 6, further comprising:
a commodity information cache module, adapted to store attribute information of the commodities selected by the user;
the order generating module is adapted to generate one on-line order for each commodity ID of the commodities selected to buy by the user according to the attribute information of the commodities selected by the user and stored in the commodity information cache module.

8. The system of claim 7, the commodity information cache module is in a user network terminal or a background server of the system.

9. The system of claim 6, the order payment module comprises:
a payment request parallel transmitting module, adapted to transmit the multiple on-line payment requests in parallel to a payment system.

10. The system of claim 6, the order payment module comprises:
a payment request combining and transmitting module, adapted to combine the multiple on-line payment requests into one on-line payment request, and transmit the combined on-line payment request to a payment system to perform payment.
